(19) United States
(12) Patent Application Publication
(10) Pub. No.: US 2003/0236612 A1
(43) Pub. Date: Dec. 25, 2003

(54) Application for diminishing or avoiding the unwanted effects of traffic congestion

(76) Inventor: Jorge Osvaldo Ambort, Zurich (CH)

Correspondence Address: Jorge Osvaldo Ambort, 5506 Jordan Road, Bethesda, MD, 20816, US

(21) Appl. No.: 10/177,268

(22) Filed: Jun. 24, 2002

(51) Int. Cl. G06G 7/76

(52) U.S. Cl. 701/117

(57) ABSTRACT

Traffic congestion occur mainly through lack of consideration for the driver from the traffic authorities.

At present the existing process to diminish or avoid traffic jams by diverting the traffic to less congested roads proves to be absolutely ineffective. Main reason is the lack of alternative routes, for example at border crossings, on motorways or construction sites for repairing purposes.

The presented application's main priority is to avoid the “stop and go” driving behaviour. Highest fuel consumption and concentrated gas emissions are the negative effects of such behaviour.

If the complete amount of vehicles involved in the traffic congestion are gradually held back in sections, it allows the effective liberation of the so called critical area. This area only gets congested due to the growing traffic concentration and will effectively be liberated with the explained application. Unwanted side effects of a traffic congestion, such has increased use of fuel, pollution emission, increase of accidents, driving stress, national economic losses and unfavourable relationship between drivers and traffic authorities can be avoided or at least be reduced considerably.

Additionally a substantial reduction of congestion time as well as amount of involved vehicles can be expected.

Traffic congestions occur mainly through lack of consideration for the driver from the traffic authorities.

At present the existing process to diminish or avoid traffic jams by diverting the traffic to less congested roads proves to be absolutely ineffective. Main reason is the lack of alternative routes, for example at border crossings, on motorways or construction sites for repairing purposes.

Processes, influencing the speed of the vehicle (alternating signals suggesting adequate speed limits) are methods highly depending on the driver respecting them. It is a fact, that alternative routes and deviations as well as speed limit suggestions mentioned above can not be safely manipulated.

The presented application's main priority is to avoid the “stop and go” driving behaviour. Highest fuel consumption and concentrated gas emissions are the negative effects of such behaviour.

This new application takes closer consideration of travel time as well as length of traffic jam. The drivers are confronted with one single driving behaviour and one single route only.

Travelling through a congested area depends highly on the “stop and go” driving behaviour of each driver. The amount of time used by vehicles to pass a traffic jam is the key issue of this claim for patent.

a) Amount of time used by each individual vehicle x in a “stop and go” driving behaviour

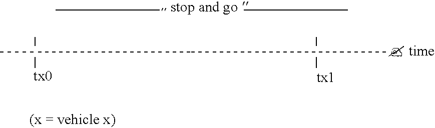

b) Newly defined travelling time

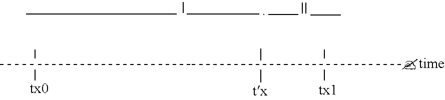

I) Time without motion (“Stop and wait . . . )

II) Time for normal driving ( . . . then go later without stopping.”

The main target of the inventor is to interchange the “stop and go” driving behaviour with a “stop and wait, then go later without stopping” driving behaviour. This includes the treatment of time.

The treatment of space or area occupied for the traffic jams is based on a continues backward movement of the traffic congestion, meaning a movement towards the area of less traffic.

### THE MAIN TASK OF THE APPLICATION IS AS FOLLOWS

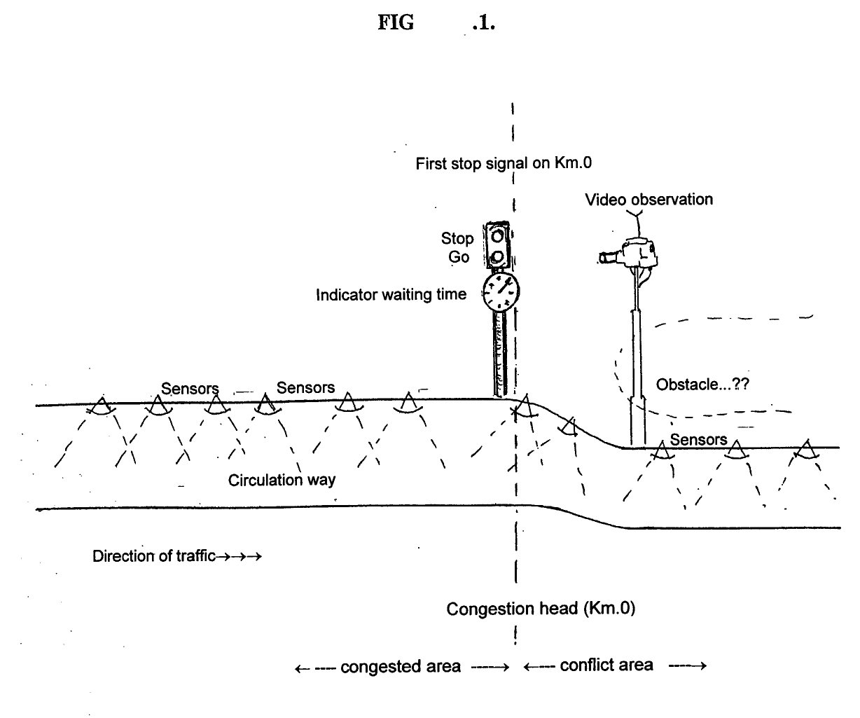

After the source of congestion has been located (examples are: a road work area on the motorway, which is going to be present for a number of months or a boarder crossing with seasonal congestion or maybe a well known area for accidents etc.) a sensor signal communication system is installed (FIG. 1) For accidents the application requires a light system with easy positionable elements.

A so called congestion head is defined for each situation through the system or a video surveillance. The sensors which are installed in the forward area of the congestion head detect the expected liberation of the critical road parts (FIG. 1)

Further sensors, located backward from the congestion head detect the gradual and later on total standstill of the vehicles and subsequently the following liberation of the critical road part.

The congested area is divided into smaller sections. The length of each section depends on the driving behaviour and the geography of the congested area. For normal traffic jams due to road works the section length is somewhere around 100 metres.

For the above example every 100 metres a signal is installed at the boundary of each section showing either a “stop” or “go” display.

Every section has sensors detecting either a standstill or flowing of traffic in the sensitive areas. They will however not detect the speed of the traffic.

### The Method

The traffic jam is detected as soon as a particular area shows the “stop and go” driving behaviour. This means, a certain amount of vehicles have gone through a temporary standstill and the sensors have determined the congestion head. The congestion head is usually just preceding the actual cause of the congestion.

The first 200-300 metres of congestion are surveyed. It is also possible to survey a shorter distance of “stop and go” driving behaviour, but research has shown, that the actual duration of a traffic jam gets shorter the earlier it gets detected and measures are taken.

As soon as an actual traffic congestion has been detected, the first stop signal preceding the congestion head is activated. The sensors in between will detect a liberation of the conflict area. Meanwhile further sections one after the other get affected by the situation and the vehicles slowly stop down one by one.

The sensors inform the central computer and it will activate the next stop signal for the second section and so on.

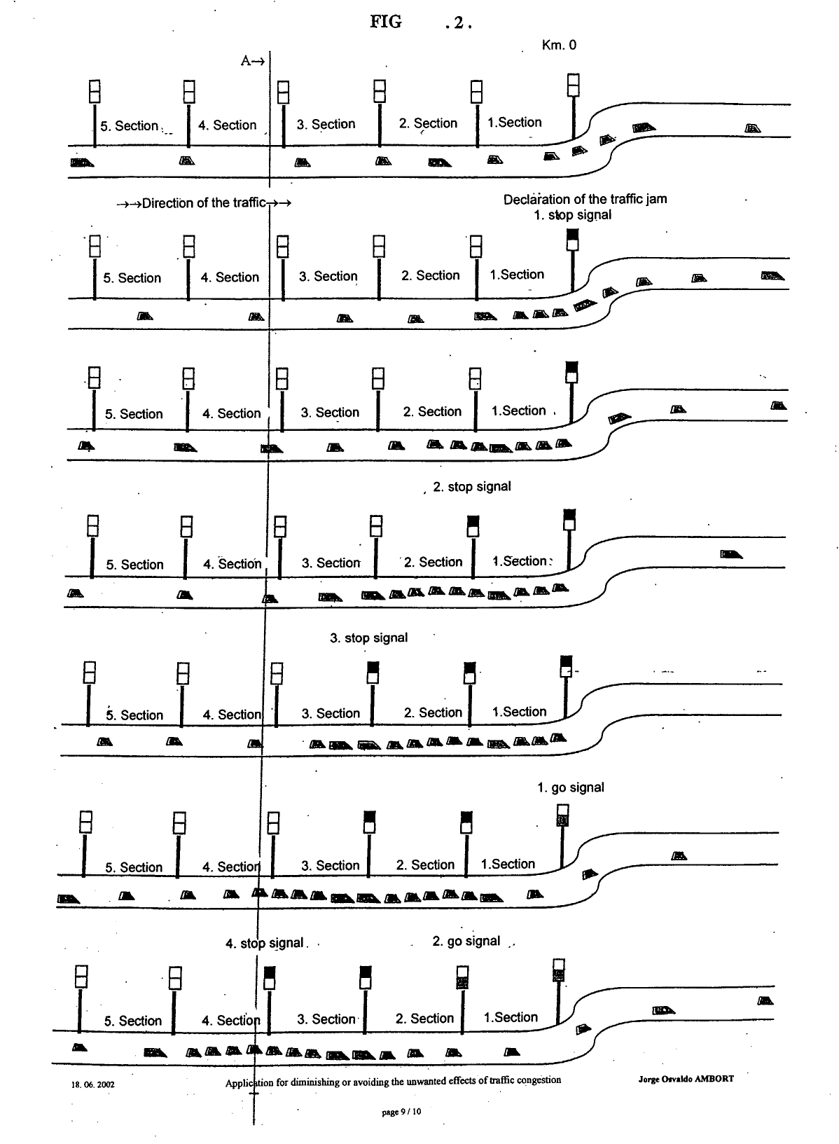

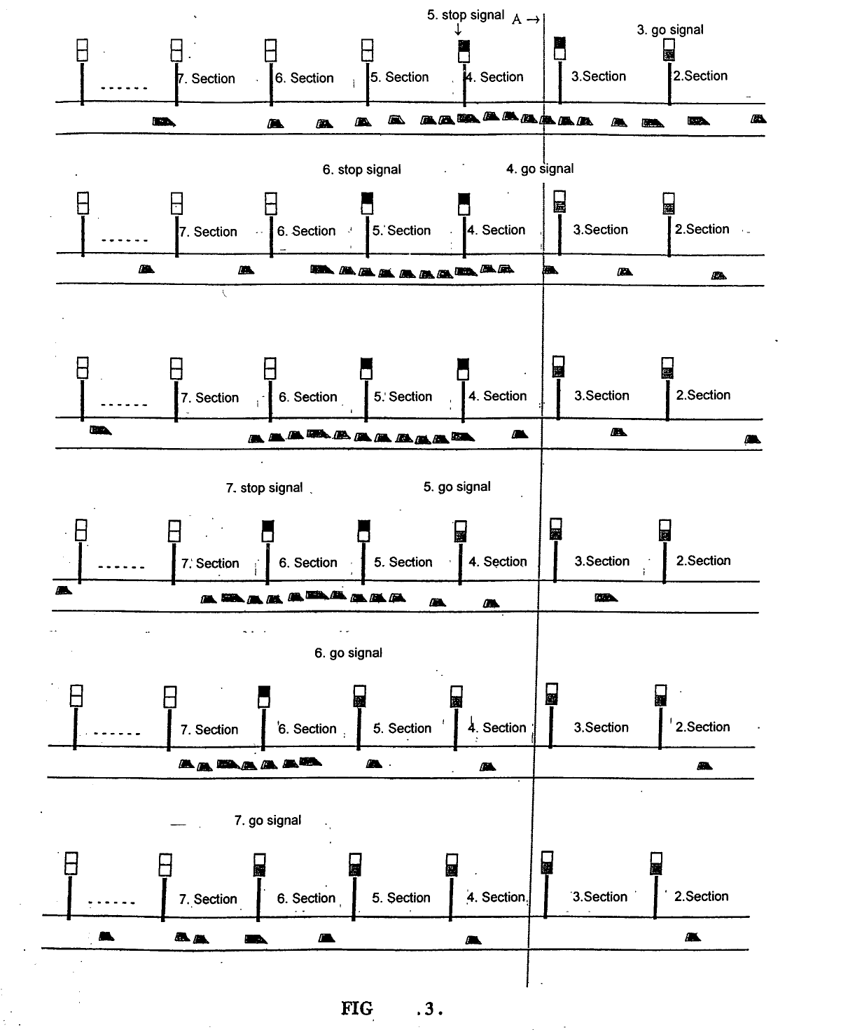

Meanwhile the conflict area has been liberated and therefore the signal for the first section turns green and vehicles can move again. After the first section is liberated the second section gets the right to go and so on until the last section gets liberated ending the traffic congestion (FIGS. 2 and 3, refer to the points by the signals).

1. Application to solve respectively to avoid the unwanted side effects of traffic congestion such has increased use of fuel, pollution emission, increase of accidents, driving stress, national economic losses and unfavourable relationship between drivers and traffic authorities. Main target is to interchange the “stop and go” driving behaviour with a “stop and wait, then go later without stopping” driving behaviour.

2. The application as set forth in claim 1, wherein adequate measures (sensors) are placed to seize the amount of vehicles in a standstill position or with a “stop and go” driving behaviour. This means, that vehicles are alternatively standing still or in a short period of slow movement. The data-processing sensors are interconnected to a communication system or else the flow of traffic is supervised by video equipment or human surveillance, counting the amount of vehicles. According to the data in comparison to a determined standard amount of vehicles as well as the driving behaviour (“stop and go” or flowing) and geography of the congested area the status of traffic jam is declared.

3. The application as set forth in claim 1, wherein the congestion head (FIG. 1), determined as km-position 0, is defined as the location where the first vehicle has been detected in a standstill position. From this position forward in direction of the traffic the area is declared a critical area (FIG. 1). From this same position backward to the direction of traffic the area is declared a congestion area (FIG. 1).

4. The application as set forth in claim 1, wherein the stop and go signals (for example traffic lights) are situated along the whole conflict area where traffic congestion usually occurs. The first signal is located at the congestion head mastering the “stop and go” driving behaviour and forcing the vehicles to a standstill. Each driver should then turn of the engine and wait in the “stop and wait” position. This procedure will give the other vehicles the chance to fill up all the other lanes if available and wait for the liberation of the critical area ahead.

5. The application as set forth in claim 1, wherein the system detects the conflict area starting from the first stop signal preceding the congestion head. The central computer receives the data revealing the size of congestion and the acting liberation of the conflict area and controls a smooth procedure.

6. The application as set forth in claim 1, wherein the declaration of congestion and moreover the determination of the congestion head together with the first stop signal triggers the controlled reaction of the preceding stop signal (100-200 metres) as the area slowly fills up with stopping vehicles depending on driving behaviour and geography of the congested area. Every stop signal activates the preceding one when adequate, forcing the whole traffic jam into sections with a signal at each boundary.(FIGS. 2 and 3)

7. The application as set forth in claim 1, wherein simultaneously to the gradual division of the traffic congestion into sections the waiting-time is displayed to inform the individual driver about the delay in each section. This information prevents the driver from unawareness of waiting-time and he is constantly updated about the situation.
$$Waiting \text{-} {time}_{ia} = f ( Section \text{-} number ) = ( {P}_{na} - {P}_{nb} ) \times {t}_{ia}$$
$$with \{ \begin{matrix}{P}_{na} = Section \text{-} number for the actually displayed \text{-} waiting \text{-} time . \\ {P}_{nb} = Section \text{-} number for the currently . being \text{-} liberated \text{-} area . \\ {t}_{ia} = \frac{1}{{P}_{nb}} {\sum }_{j = 1}^{{P}_{nb}} Liberation \text{-} time '' j '' .\end{matrix} \\ Liberation \text{-} {time}_{ia} is the time '' t '' shown for section '' a '' .$$

8. The application as set forth in claim 1, wherein the reaching of a normal traffic volume in the critical area, causes the first sector to be liberated through the first signal turning to “go”. After the traffic volume has reached the normal standard in that first section, the next section is liberated and so on until the end of the process has been reached. With this procedure the “go later without stopping” driving behaviour is established as determined in the requested claim for patent (FIGS. 2 and 3).
